(19) United States
(12) Patent Application Publication
(10) Pub. No.: US 2002/0144548 A1
(43) Pub. Date: Oct. 10, 2002

(54) High precision accelerometer

(76) Inventors: Michael B. Cohn, Berkeley, CA (US); Ryan Roehnelt, Alameda, CA (US)

Correspondence Address: Wallace Tang, MicroAssembly Technologies, Inc., 3065 Richmond Pkwy Suite 109, Richmond, CA, 94806, US

(21) Appl. No.: 10/118,542

(22) Filed: Apr. 8, 2002

Related U.S. Application Data
(60) Provisional application No. 60/282,117, filed on Apr. 6, 2001.

(51) Int. Cl. G01P 15/00

(52) U.S. Cl. 73/514.16; 73/488

(57) ABSTRACT

The present invention provides an accelerometer which is more manufacturable, higher performance, and more survivable. This invention is particularly applicable for ultra-low-g sensors and ultra-high-g sensors.

This application is based on provisional patent application No. 60/282,117 with a filing date of Apr. 6, 2001 entitled “High Precision Micro-Machined Accelerometer Patent”.

### STATEMENT REGARDING FEDERALLY SPONSORED RESEARCH OR DEVELOPMENT

This invention was partially supported by U.S. Army Aviation and Missile Command under Contact No.: DAAH01-00-C-R007.

### TECHNICAL FIELD OF THE INVENTION

The present invention relates to providing accelerometers with improved performance, manufacturability and reliability. This is particularly important for accelerometers designed to measure very small accelerations for applications including but not limited to inertial measurement units. This is also important for improving survivability for accelerometers for high-g applications, including but not limited to munitions fuzing.

### BACKGROUND OF THE INVENTION

Microelectromechancial systems (MEMS) have been utilized for the development of low-cost sensors. For example, the commercial availability of low-cost surface-micromachined accelerometers was critical for the wide-deployment of automotive airbags. More sensitive surface micromachined accelerometers have been developed for low-g applications, including but not limited to tilt sensing and joysticks. Bulk micromachined accelerometers are often higher performance, but are significantly more expensive. The current invention provides accelerometers that are more manufacturable for higher manufacturing yields. The current invention also provides accelerometers that have a larger dynamic range. Another benefit of the current invention is improved survivability for accelerometers subjected to high-g environments.

Surface micromachined accelerometers are manufactured by various groups, including but not limited to Analog Devices and Motorola.

Other accelerometer suppliers, such as for bulk micromachined accelerometers, include but are not limited to Honeywell and Endevco

Manufacturability of Surface Micromachined Accelerometers

FIGS. 1 and 2 illustrate the common comb finger design for surface micromachined accelerometers. Variants of this approach are used by both Analog Devices and Motorola for their products. comb finger, 8, are generally long thin elements. These fingers are prone to stiction problems that can permanently or temporarily impair device function. Examples of stiction problems include but are not limited to comb finger, 8, sticking to each other, to the substrate, or to device packaging surfaces. Stiction problems can be addressed by increasing the spring constants of the accelerometer, including but not limited to spring constant of the vanes or comb fingers, 8, and the device suspension or springs, 12. However, increasing the spring constant of the device suspension typically reduces device signal strength.

Accelerometers in High-g Environments

High-g environments can cause accelerometer failure. Failures can result from various mechanisms, including but not limited to comb finger stiction problems or actual detachment (breakage) of fragile device components. Accelerometers can be made more durable by various means, including but not limited to increasing device spring constant. However, increasing device spring constant typically reduces device signal strength.

Dynamic Range of Accelerometers

Accelerometers have dynamic range limitations stemming from stiction (primarily for low g accelerometers) during manufacturing, and durability for higher-g applications. For example, with the typical low-g, capacitance-sensing, comb-finger-type accelerometers, acceleration is measured by sensing a change in capacitance resulting from a gap change between the comb fingers, 8. Thus, the device needs to have a low device suspension, 12, spring constant in order for a small acceleration to cause a sufficient gap change between comb fingers, 8. For an extremely sensitive accelerometer, an extremely low device suspension, 12, spring constant is needed. Consequently, devices of this type may be more prone to damage during manufacturing, particularly from stiction of the comb fingers, 8, to each other, to the substrate, or to other parts of the accelerometer.

For high-g applications, a fast reacting device is often desired. Fast device response generally requires a high resonant frequency. However, for the device to have a high resonant frequency, it would generally need to have very large device suspension, 12, spring constants. This would limit the sensitivity, thus the dynamic range, of the device.

### BRIEF SUMMARY OF THE INVENTION

This invention can be used to provide accelerometers which are higher performance, including but not limited to larger dynamic range. This invention can also be used to provide accelerometers with improved manufacturability and survivability.

This invention describes an accelerometer which consist of more than one sensing element, wherein said more than one sensing elements are electrically interconnected together. Typically, individual sensing elements have larger spring constants, improved manufacturability, and improved survivability. The sensing elements can be electrically interconnected in various configurations, including but not limited to a serial fashion, parallel fashion, or a combination of serial and parallel interconnections. The preferable sensing element is a comb-finger structure, 8. Other sensing elements include but are not limited to membrane structure, cantilevers, or any combination of these structures.

This accelerometer is particularly useful in the high g and very low g ranges. Linear accelerometers, rotary accelerometers, and paired linear accelerometers (simulating rotary accelerometers) can be provided using this design.

In our current invention, these electrical connections are formed by various means, including but not limited to:

a. all sensing elements are interconnected with at least one device layer between the device substrate and the device elements,

b. all sensing elements are interconnected with at least one layer of the sensing elements,

c. all sensing elements are interconnected with at least one device layer deposited above said device elements,

d. all sensing elements are interconnected with at least one device layer on at least one separate substrate, wherein said at least one separate substrate is bonded, preferably bump bonded, to at least one sensing element substrate,

e. any combination of the above arrangements.

Preferably, the electrical interconnection is performed using at least one device on at least one separate substrate, wherein said at least one separate substrate is bump bonded to at least one sensing element substrate

Improvement in performance, particularly dynamic range and/or sensitivity is possible. For low-g applications, stiction and other reliability problems effectively set a lower limit for device suspension, 12, spring constants. However, with the use of multiple sensing elements, for the same acceleration, a larger change in capacitance is made possible by taking advantage of the multiple sensing element outputs. For high-g applications, higher spring constants are desired, thereby limiting device sensitivity. Thus, by using multiple sensing elements, smaller accelerometers can also be sensed without lowering device spring constants.

### BRIEF DESCRIPTION OF SEVERAL OF THE DRAWINGS

FIG. 1.—Simplified electrical schematic of comb type accelerometer array with both series and parallel connections. The three columns are connected in parallel (2) at the control electronics interface (1). Each column of elements (3) is connected in series by a conductive path (4).

FIG. 2.—Each element of the array may be made up of a common comb finger type accelerometer. The elements of the accelerometer are the shuttle (5), left stator (6), right stator (7), projecting from the shuttle and the stators are the interdigitated comb fingers which act as the charged capacitive plates (8). As an acceleration is experienced by an element, the shuttle moves on its spring suspension, changing the gap between the fingers, which causes a change in capacitance.

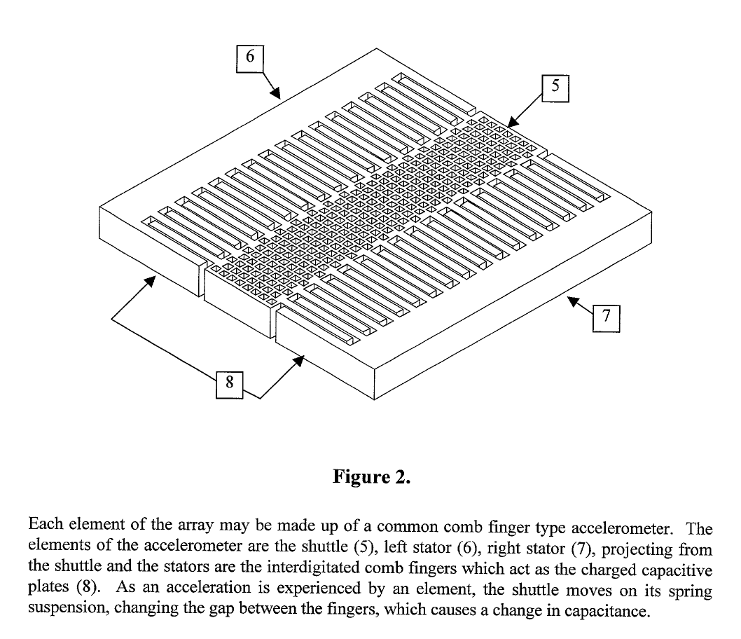

FIG. 3.—Shown is a single element of a high g accelerometer array. This particular type of comb drive accelerometer operates in a differential nature with capacitance on the left, or low, stator (9) increasing while the capacitance on the right, or high, stator (10) decreases for an acceleration that would cause the shuttle (11) to move downward relative to the stators. The shuttle is supported on a set of springs (12), which are anchored on the substrate by large support areas (13). The stators are anchored by large support areas (14).

### DETAIL DESCRIPTION OF THE INVENTION

Accelerometer Design

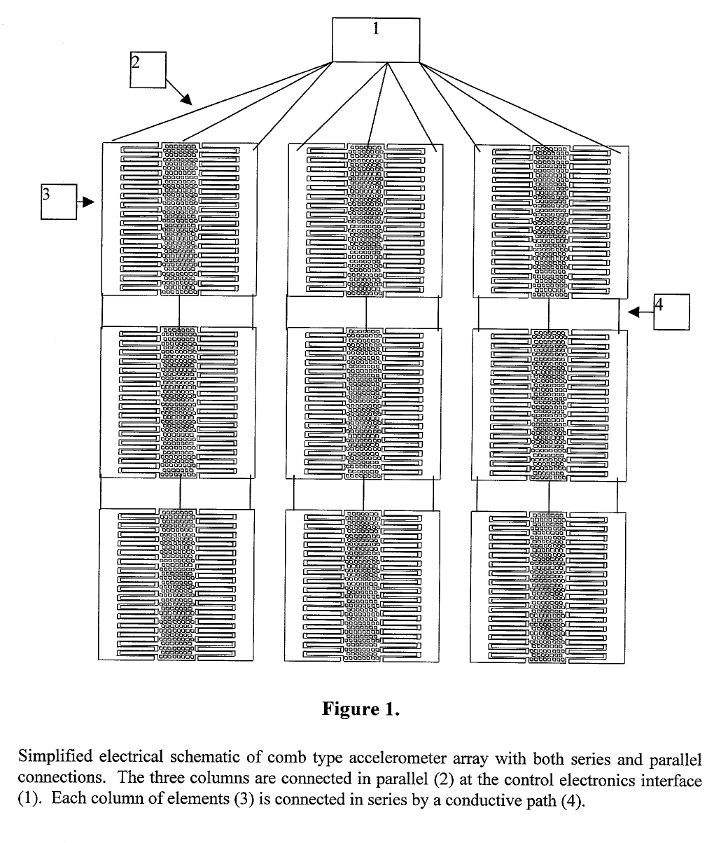

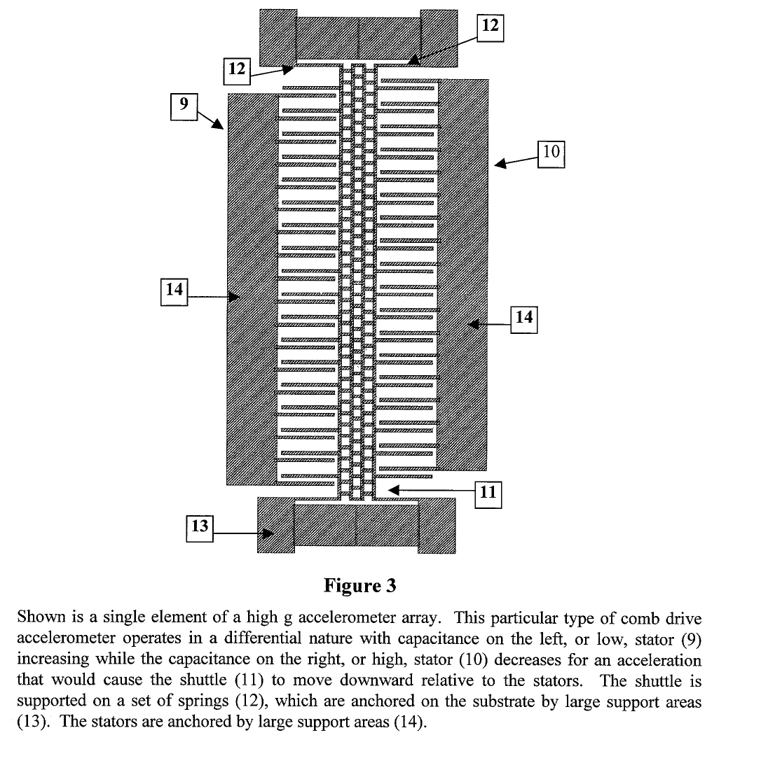

An accelerometer with improved survivability, performance (such as dynamic range), and manufacturability is provided by fabricating more than one sensing elements and electrical interconnect said more than one sensing elements together. FIG. 1 illustrates this approach which interconnects more than one sensing element. Said more than one sensing elements include but are not limited to the following list: (a) comb fingers, 8, attached to at least one mass and attached to at least one spring, (b) membrane, (c) cantilever, or (d) any combination. The sensing elements are preferably comb fingers, 8, attached to at least one mass and at least two springs. FIG. 3 is an example of a comb finger type accelerometer. Preferably, said more than one sensing elements are electrical interconnected together in an arrangement selected from the following list:

a. all sensing elements are interconnected in series,

b. all sensing elements are interconnected in parallel,

c. all sensing elements are interconnected in any combination of series and parallel interconnections.

The following is one process flow embodiment for fabricating the MEMS substrate with doped polysilicon as the structural layer for the MEMS device:

a. Deposit at least 2 microns of undoped silicon oxide layer on bare silicon wafer substrate by chemical vapor deposition.

b. Deposit at least 2 microns of doped polysilicon structural layer by chemical vapor deposition, and anneal the wafer at high temperatures (such as 1000° C.) to remove stress.

c. Optionally, silicon nitride layer is deposited by chemical vapor deposition, coat and pattern photoresist layer, etch silicon nitride layer preferably by dry etch process, and remove photoresist layer by standard dry or wet processes.

d. Coat and pattern photoresist layer.

e. Etch polysilicon layer preferably by dry etch process.

f. Remove photoresist layer using standard wet or dry processes.

g. Partially etch the bottom undoped silicon oxide layer to release the sensing elements for movement,

h. Interconnect different sensing elements together.

The following is another process flow embodiment for fabricating the MEMS substrate with doped polysilicon as the structural layer for the MEMS device:

a. Deposit at least 2 microns of undoped silicon oxide layer on bare silicon wafer substrate by chemical vapor deposition.

b. Deposit at least 2 microns of doped polysilicon structural layer by chemical vapor deposition, and anneal the wafer at high temperatures (such as 1000° C.) to remove stress.

c. Optionally, silicon nitride layer is deposited by chemical vapor deposition, coat and pattern photoresist layer, etch silicon nitride layer preferably by dry etch process, and remove photoresist layer by standard dry or wet processes.

d. Deposit metal layer, preferably by sputtering, preferably titanium tungsten (TiW) layer. Other metal layers that can be deposited include but are not limited to:

titanium nitride, titanium, tantalum, tantalum nitride, chromium, gold, metal silicides, platinum, nickel, other metals, alloys of these materials, or any combination of these materials,

e. Optionally, deposit additional metal layer, preferably deposited by sputtering. A gold layer is preferred. Other metal layers that can be deposited include but are not limited to: titanium tungsten, platinum, titanium, titanium nitride, titanium tungsten, nickel, copper, metal silicides, other metals, alloys of these materials, or any combination of these materials.

f. Coat and pattern photoresist layer.

g. Etch said one or more metal layers by dry etching, wet processing, or any combination.

h. Remove photoresist by standard wet or dry processes.

i. Coat and pattern photoresist layer.

j. Etch polysilicon layer preferably by dry etch process.

k. Remove photoresist layer using standard wet or dry processes.

l. Partially etch the bottom undoped silicon oxide layer to release the sensing elements for movement,

m. Interconnect different sensing elements together.

The following is one process flow embodiment for fabricating the MEMS substrate with single crystalline silicon as the structural layer for the MEMS device:

a. Start with silicon on insulator (SOI) wafer, preferably with at least 2 microns of oxide layer, and a thick single crystalline silicon layer, such as an at least 20 micron thick layer.

b. Optionally, silicon nitride layer is deposited by chemical vapor deposition, coat and pattern photoresist layer, etch silicon nitride layer preferably by dry etch process, and remove photoresist layer.

c. Deposit metal layer, preferably by sputtering, preferably titanium tungsten (TiW) layer. Other metal layers that can be deposited include but are not limited to: titanium nitride, titanium, tantalum, tantalum nitride, chromium, gold, metal silicides, platinum, nickel, other metals, alloys of these materials, or any combination of these materials,

d. Optionally, deposit additional metal layer, preferably deposited by sputtering. A gold layer is preferred. Other metal layers that can be deposited include but are not limited to: titanium tungsten, platinum, titanium, titanium nitride, titanium tungsten, nickel, copper, metal silicides, other metals, alloys of these materials, or any combination of these materials.

e. Coat and pattern photoresist layer.

f. Etch said one or more metal layers by dry etching, wet processing, or any combination.

g. Remove photoresist by standard wet or dry processes.

h. Coat and pattern photoresist layer.

i. Etch silicon layer preferably by dry etch process.

j. Remove photoresist layer using standard wet or dry processes.

k. Partially etch the bottom undoped silicon oxide layer to release the sensing elements for movement,

l. Interconnect different sensing elements together.

Interconnecting the Sensing Elements

A device as in claim 1 wherein said electrical interconnections are provided by an arrangement selected from the following list:

a. all sensing elements are wirebonded together,

b. all sensing elements are interconnected with at least one device layer between the substrate and the device elements,

c. all sensing elements are interconnected with at least one layer of the sensing elements,

d. all sensing elements are interconnected with at least one device layer deposited above said device elements,

e. all sensing elements are interconnected with at least one device layer on at least one separate substrate, wherein said at least one separate substrate is bonded, preferably bump bonded, to at least one sensing element substrate,

f. any combination of the above arrangements.

The preferable electrical interconnection method is to interconnect all the sensing elements using at least one layer of the sensing elements. The other preferred electrical interconnection method is to interconnect all sensing elements with at least one device layer on at least one separate substrate, wherein said at least one separate substrate is bonded to at least one sensing element substrate. Gold bump bonding is the preferred bonding method for electrical interconnection. Other bonding methods can be used, including but not limited to:

a. gold bump bonding

b. indium bump bonding,

c. polymer bump bonding,

d. bump bonding with gold on at least one bonding surface,

e. bump bonding with solder on at least one bonding surface,

f. bump bonding with indium on at least one bonding surface,

g. bump bonding with conductive polymer on at least one bonding surface,

h. bump bonding wherein an adhesive provides the majority of the bonding strength between said substrates,

i. bump bonding wherein a solder bond provides the majority of the bonding strength between said substrates,

j. bump bonding wherein a gold thermal compression bond provides the majority of the bonding strength between said substrates,

k. bump bonding wherein a gold compression bond provides the majority of the bonding strength between said substrates,

l. bump bonding wherein the majority of the bonding strength between said substrates is provided from a bonding process involving the formation of at least one amalgam,

m. bump bonding wherein the majority of the bonding strength between said substrates is provided from a cold welding process,

n. any combination of the above bump bonding processes.

Process Flow Embodiments with Multiple Substrates

The process flow embodiments involve the fabrication of a MEMS substrate and an interconnect substrate, and bonding the two substrates together utilizing one of the bonding processes as discussed in the bonding process section. The preferable bonding process for bonding and interconnecting the substrates together is gold bump bonding by thermal compression or cold welding. Preferably, the gold bump bonding process is also utilized to provide sealing for the accelerometer by defining rings of bonding materials instead of simply bumps for electrical interconnection.

The following is one process flow embodiment for fabricating the MEMS substrate with doped polysilicon as the structural layer for the MEMS device:

a. Deposit at least 2 microns of undoped silicon oxide layer on bare silicon wafer substrate by chemical vapor deposition.

b. Deposit at least 2 microns of doped polysilicon structural layer by chemical vapor deposition, and anneal the wafer at high temperatures (such as 1000° C.) to remove stress.

c. Optionally, silicon nitride layer is deposited by chemical vapor deposition, coat and pattern photoresist layer, etch silicon nitride layer preferably by dry etch process, and remove photoresist layer by standard dry or wet processes.

d. Coat and pattern photoresist layer.

e. Etch polysilicon layer preferably by dry etch process.

f. Remove photoresist layer using standard wet or dry processes.

g. Deposit metal layer, preferably by sputtering, preferably titanium tungsten (TiW) layer. Other metal layers that can be deposited include but are not limited to: titanium nitride, titanium, tantalum, tantalum nitride, chromium, gold, metal silicides, platinum, nickel, other metals, alloys of these materials, or any combination of these materials,

h. Optionally, deposit an additional metal layer, preferably deposited by sputtering. A gold layer is preferred. Other metal layers that can be deposited include but are not limited to: titanium tungsten, platinum, titanium, titanium nitride, titanium tungsten, nickel, copper, metal silicides, other metals, alloys of these materials, or any combination of these materials.

i. Coat and pattern photoresist layer.

j. Etch said one or more metal layers by dry etching, wet processing, or any combination.

k. Remove photoresist by standard wet or dry processes.

l. Partially etch the bottom undoped silicon oxide layer to release the sensing elements for movement

The following is another process flow embodiment for fabricating the MEMS substrate with doped polysilicon as the structural layer for the MEMS device:

a. Deposit at least 2 microns of undoped silicon oxide layer on bare silicon wafer substrate by chemical vapor deposition.

b. Deposit at least 2 microns of doped polysilicon structural layer by chemical vapor deposition, and anneal the wafer at high temperatures (such as 1000° C.) to remove stress.

c. Optionally, silicon nitride layer is deposited by chemical vapor deposition, coat and pattern photoresist layer, etch silicon nitride layer preferably by dry etch process, and remove photoresist layer by standard dry or wet processes.

d. Deposit metal layer, preferably by sputtering, preferably titanium tungsten (TiW) layer. Other metal layers that can be deposited include but are not limited to: titanium nitride, titanium, tantalum, tantalum nitride, chromium, gold, metal silicides, platinum, nickel, other metals, alloys of these materials, or any combination of these materials,

e. Optionally, deposit additional metal layer, preferably deposited by sputtering. A gold layer is preferred. Other metal layers that can be deposited include but are not limited to: titanium tungsten, platinum, titanium, titanium nitride, titanium tungsten, nickel, copper, metal suicides, other metals, alloys of these materials, or any combination of these materials.

f. Coat and pattern photoresist layer.

g. Etch said one or more metal layers by dry etching, wet processing, or any combination.

h. Remove photoresist by standard wet or dry processes.

i. Coat and pattern photoresist layer.

j. Etch polysilicon layer preferably by dry etch process.

k. Remove photoresist layer using standard wet or dry processes.

l. Partially etch the bottom undoped silicon oxide layer to release the sensing elements for movement.

The following is one process flow embodiment for fabricating the MEMS substrate with single crystalline silicon as the structural layer for the MEMS device: p1 a. Start with silicon on insulator (SOI) wafer, preferably with at least 2 microns of undoped silicon oxide layer, and a thick single crystalline silicon layer, preferably at least 20 microns thick.

b. Optionally, silicon nitride layer is deposited by chemical vapor deposition, coat and pattern photoresist layer, etch silicon nitride layer preferably by dry etch process, and remove photoresist layer.

c. Coat and pattern photoresist layer.

d. Etch silicon layer preferably by dry etch process.

e. Remove photoresist layer using standard wet or dry processes.

f. Deposit metal layer, preferably by sputtering, preferably titanium tungsten (TiW) layer. Other metal layers that can be deposited include but are not limited to: titanium nitride, titanium, tantalum, tantalum nitride, chromium, gold, metal silicides, platinum, nickel, other metals, alloys of these materials, or any combination of these materials,

g. Optionally, deposit additional metal layer, preferably deposited by sputtering. A gold layer is preferred. Other metal layers that can be deposited include but are not limited to: titanium tungsten, platinum, titanium, titanium nitride, titanium tungsten, nickel, copper, metal silicides, other metals, alloys of these materials, or any combination of these materials.

h. Coat and pattern photoresist layer.

i. Etch said one or more metal layers by dry etching, wet processing, or any combination.

j. Remove photoresist by standard wet or dry processes.

k. Partially etch the bottom undoped silicon oxide layer of SOI substrate to release the sensing elements for movement.

The following is another process flow embodiment for fabricating the MEMS substrate with single crystalline silicon as the structural layer for the MEMS device:

a. Start with silicon on insulator (SOI) wafer, preferably with at least 2 microns of oxide layer, and a thick single crystalline silicon layer, preferably at least 20 microns thick.

b. Optionally, silicon nitride layer is deposited by chemical vapor deposition, coat and pattern photoresist layer, etch silicon nitride layer preferably by dry etch process, and remove photoresist layer by standard wet or dry processes. c. Deposit metal layer, preferably by sputtering, preferably titanium tungsten (TiW) layer. Other metal layers that can be deposited include but are not limited to: titanium nitride, titanium, tantalum, tantalum nitride, chromium, gold, metal silicides, platinum, nickel, other metals, alloys of these materials, or any combination of these materials,

d. Optionally, deposit additional metal layer, preferably deposited by sputtering. A gold layer is preferred. Other metal layers that can be deposited include but are not limited to: titanium tungsten, platinum, titanium, titanium nitride, titanium tungsten, nickel, copper, metal silicides, other metals, alloys of these materials, or any combination of these materials.

e. Coat and pattern photoresist layer.

f. Etch said one or more metal layers by dry etching, wet processing, or any combination.

g. Remove photoresist by standard wet or dry processes.

h. Coat and pattern photoresist layer.

i. Etch the top silicon layer of the SOI wafer, preferably by dry etching,

j. Remove photoresist by standard wet or dry processes.

k. Partially etch the bottom undoped silicon oxide layer to release the sensing elements for movement.

The following is a process flow embodiment for fabricating the interconnect substrate:

a. Start with silicon dioxide substrate (including but not limited to pyrex wafers, fused quartz wafers, single crystalline quartz wafers) or silicon wafer.

b. Optionally, deposit a silicon oxide layer, preferably at least 1 micron thick, by chemical vapor deposition.

c. Deposit metal layer, preferably by sputtering, preferably titanium tungsten (TiW) layer. Other metal layers that can be deposited include but are not limited to: titanium nitride, titanium, tantalum, tantalum nitride, chromium, gold, metal silicides, platinum, nickel, other metals, alloys of these materials, or any combination of these materials,

d. Optionally, deposit additional metal layer, preferably deposited by sputtering. A gold layer is preferred. Other metal layers that can be deposited include but are not limited to: titanium tungsten, platinum, titanium, titanium nitride, titanium tungsten, nickel, copper, metal silicides, other metals, alloys of these materials, or any combination of these materials.

e. Coat and pattern photoresist layer.

f. Etch metal layer(s) preferably by a dry etch process.

g. Remove photoresist layer using standard wet or dry processes.

h. Deposit electrical insulating layer, preferably by chemical vapor deposition. Low temperature oxide is preferred, preferably at a deposition temperature below 500°C.

i. Coat and pattern photoresist layer.

j. Etch insulating layer preferably by dry etch process.

k. Remove photoresist layer using standard wet or dry processes.

l. Deposit metal layer, preferably by sputtering, preferably titanium tungsten (TiW) layer. Other metal layers include but are not limited to: titanium nitride, titanium, tantalum, tantalum nitride, chromium, gold, metal silicides, platinum, nickel, other metals, alloys of these materials, or any combination of these materials,

m. Optionally, deposit additional metal layer, preferably deposited by sputtering. A gold layer is preferred. Other metal layers that can be deposited include but are not limited to: titanium tungsten, platinum, titanium, titanium nitride, titanium tungsten, nickel, copper, metal silicides, other metals, alloys of these materials, or any combination of these materials.

n. Coat and pattern photoresist layer for electroplating mold.

o. Deposit metal bumps, preferably by electroplating, preferably gold bumps at least 2 microns thick.

p. Remove photoresist layer using standard wet or dry processes.

q. Perform a partial etch of the deposited metal layers, preferably by dry etching or sputter etch.

r. Optionally, the metal bumps can be annealed.

Preferably, gold bumps are deposited on the interconnect substrate for electrically interconnecting to metal patterns on the MEMS substrate. Alternatively, gold bumps can be deposited on the MEMS substrate for electrical interconnection to metal patterns on the interconnect substrate.

The following is a process flow embodiment for bonding and interconnecting the MEMS substrates and the interconnect substrates:

a. The substrates are aligned face-to-face in an arrangement such that the bumps or other electrical interconnection structures on one substrate are aligned with the corresponding metal patterns on the other substrate.

b. Preferably, the two substrates are then compressed together and heated, so that a bond is formed between the pad area of each spring or structure, and one of the contact pads on the chips.

c. For a cold welding embodiment, heating would not be necessary.

Substrates

The one or more substrates on which the devices are fabricated or interconnected include but are not limited to silicon, glass wafers, printed circuit boards (PCB), multichip module (MCM) substrates, low-parasitic substrates, alumina substrates, glass substrates (including but not limited to pyrex wafers, fused quartz wafers or single crystalline quartz wafers) mention both glass substrates and wafers), insulating substrates, sapphire substrates, silicon substrates, or other semiconductor substrates. The preferable substrate for fabricating said sensing elements is a silicon substrate, such as a silicon wafer or a silicon-on-insulator substrate. The preferable substrate for an electrical interconnection substrate is a silicon substrate or a silicon oxide substrate, including but not limited to a pyrex wafer, a fused quartz wafer, or a silicon wafer.

Bonding Processes

Bonding processes for providing electrical connections and/or mechanical attachment which can be used by the current invention include but are not limited to thermal compression bonding, cold welding, solder bump bonding, gold thermal compression bonding, gold-indium, indium bump, gold-tin, eutectic bonding, polymer bump, adhesive bonding, bonding involving the formation of one or more amalgams, or any combination of these processes.

In cases wherein there are fragile bonds, a soft underfill may be used to protect these bonds. The underfill material may be applied to the whole underside of the chip, or selectively, e.g. to the corners or under the center. Other additional means for providing mechanical stability can also be used, including but not limited to thermal compression bonding, cold welding, solder bonding, polymer bump bonding, solder bump bonding, eutectic bonding, adhesive bonding, bonding involving the formation of one or more amalgams, or any combinations of these processes.

In cases where the gap between the substrates is important, spacers can be used to control the gap during and/or after the bonding process. Preferably in these cases, the spacers are fabricated using any, some, or all of the existing device or packaging layers, without adding additional layers.

Sealing and Packaging Processes for the Accelerometer

The accelerometer can be packaged and sealed using conventional packaging methods, including but not limited to using ceramic or metal hermetic packages.

Alternatively, and preferably, the bump bonding process also seals the sensing elements. This is preferably achieved by sealing the sensing elements by surrounding said sensing elements by at least one seal ring. Said at least one seal ring is preferably fabricated using the same device layers as the bumps for interconnecting the substrates. The preferred sealing ring material is electroplated gold. Other sealing ring materials include but are not limited to indium, solders, conductive polymers, and any combination of these materials.

Fabrication Processes for the Accelerometer

Various microfabrication processes can be used to fabricate the accelerometer. Deposition processes include but are not limited to sputtering, evaporation, electroplating, electroless plating, chemical vapor deposition, spin coating, or laser assisted processes. Etching processes include but are not limited to plasma etching, RIE etching, chemical etching, wet etching, ion milling, polishing, chemical mechanical polishing, lapping, or grinding. Photolithography would be the preferable means for patterning the various layers.

Simple embodiments would have structural and sacrificial layers. Part of, if not all of, the sacrificial layers are etched away during fabrication. In some cases, it is even possible to use the same material as both structural and sacrificial layer.

Sacrificial Layers

Sacrificial layers can be layers of various materials, including but not limited to silicon oxide, undoped silicon oxide, germanium, aluminum, other metals, polyimide, olymers, graphite, or any combination of these materials.

For devices with polysilicon or single crystalline silicon as a structural layer, a osilicate glass is preferably deposited, preferably at least 1-2 μm in thickness, or other riate thickness to act as a sacrificial layer.

Structural Layers

Structural layers of the sensing elements can be one or more layers of various materila including but not limited to polysilicon, silicon carbide, single crystalline silicon, silicon-germanium, other semiconductor, nickel, other metals, alloys, silicon oxide, silicon oxynitrite, other ceramics, polymer, alumina, or any combination of these materials. The preferable materials are polysilicon and single crystalline silicon. The deposition processes and etching processes for forming the structural layers are listed in the Fabrication Processes section.

What is claimed is:

1. An accelerometer with more than one sensing element wherein said more than one sensing elements are electrically interconnected together.

2. A device as in claim 1 wherein said more than one sensing elements are electrically interconnected together in an arrangement selected from the following list:
a. all sensing elements are interconnected in series,
b. all sensing elements are interconnected in parallel,
c. all sensing elements are interconnected in any combination of series and parallel interconnections.

3. A device as in claim 1 wherein said more than one sensing elements are electrically interconnected together in parallel.

4. A device as in claim 1 wherein each sensing element of said more than one sensing elements is selected from the list:
a. comb fingers attached to at least one mass and attached to at least one spring
b. membrane
c. cantilever, or
d. any combination.

5. A device as in claim 1 wherein each sensing element of said more than one sensing elements comprises comb fingers attached to at least one mass and attached to at least two springs.

6. A device as in claim 1 wherein said electrical interconnections are provided by an arrangement selected from the following list:
a. all sensing elements are interconnected by wirebonding,
b. all sensing elements are interconnected with at least one device layer between the device substrate and the device elements,
c. all sensing elements are electrically interconnected by one or more layers of said sensing elements,
d. all sensing elements are interconnected with at least one device layer deposited above said device elements,
e. all sensing elements are interconnected with at least one device layer on at least one separate substrate, wherein said at least one separate substrate is bonded to at least one sensing element substrate,
f. any combination of the above arrangements.

7. A device as in claim 6 wherein said at least one separate substrate is bonded to said at least one sensing element substrate with a bonding technique selected from the following list:
a. gold bump bonding,
b. solder bump bonding,
c. indium bump bonding,
d. polymer bump bonding,
e. bump bonding with gold on at least one bonding surface,
f. bump bonding with solder on at least one bonding surface,
g. bump bonding with indium on at least one bonding surface,
h. bump bonding with conductive polymer on at least one bonding surface,
i. bump bonding wherein an adhesive provides the majority of the bonding strength between said substrates,
j . bump bonding wherein a solder bond provides the majority of the bonding strength between said substrates,
k. bump bonding wherein a gold thermal compression bond provides the majority of the bonding strength between said substrates,
l. bump bonding wherein a gold compression bond provides the majority of the bonding strength between said substrates,
m. bump bonding wherein the majority of the bonding strength between said substrates is provided from a bonding process involving the formation of at least one amalgam,
n. bump bonding wherein the majority of the bonding strength between said substrates is provided from a cold welding process,
o. any combination of the above bump bonding processes.

8. A device as in claim 7 wherein the bonding process also seals the sensing elements.

9. A device as in claim 8 wherein the sensing elements are hermetically sealed.

10. A device as in claim 8 wherein the sensing element are vacuum-tight sealed.

11. A device as in claim 7 wherein said bonding process seals the sensing elements by surrounding said sensing elements by at least one seal ring.

12. A device as in claim 11 wherein said at least one seal ring is fabricated using the same device layers as the structures for interconnecting the substrates.

13. A method of fabricating an accelerometer wherein more than one sensing elements are electrically interconnected together.

14. A method as in claim 13 wherein said more than one sensing elements are electrically interconnected together in an arrangement selected from the following list:
a. all sensing elements are interconnected in series,
b. all sensing elements are interconnected in parallel,
c. all sensing elements are interconnected in any combination of series and parallel interconnections.

15. A method as in claim 13 wherein said more than one sensing elements are electrically interconnected in parallel.

16. A method as in claim 13 wherein each sensing element of said more than one sensing elements are selected from the list:
a. comb fingers attached to at least one mass and attached to at least one spring,
b. membrane,
c. cantilever, or
d. any combination.

17. A method as in claim 13 wherein each sensing element of said more than one sensing elements comprises comb fingers attached to at least one mass and attached to at least two springs.
